(19) United States
(12) Patent Application Publication
(10) Pub. No.: US 2018/0284531 A1
(43) Pub. Date: Oct. 4, 2018

(54) LIQUID CRYSTAL DISPLAY DEVICE

(71) Applicant: Shenzhen China Star Optoelectronics Technology Co., Ltd., Shenzhen City (CN)

(72) Inventors: Lixuan Chen, Shenzhen City (CN); Yungjui Lee, Shenzhen City (CN)

(21) Appl. No.: 15/539,697

(22) PCT Filed: Apr. 19, 2017
(86) PCT No.: PCT/CN2017/081027

§ 371 Date: Jun. 26, 2017

(30) Foreign Application Priority Data
Mar. 31, 2017 (CN) 201710211521.5

(51) Int. Cl. G02F 1/1335; G02F 1/1368; G02F 1/1333; G02F 1/1362

(52) U.S. Cl. CPC G02F 1/133514; G02F 1/1368; G02F 1/13362; G02F 1/133528; G02F 1/133345; G02F 2001/133531; G02F 2001/136222; G02F 2001/133548; G02F 2001/133614; G02F 2001/133357; G02F 1/136227

(57) ABSTRACT

The present invention provides a liquid crystal display device, which includes a liquid crystal panel including a first substrate and a second substrate respectively arranged at upper and lower sides and opposite to each other, wherein the first substrate and the second substrate respectively include one of a quantum dot color filter plate and an optic film layer. The present invention is structured to have the quantum dot color filter plate and the optic film layer respectively arranged on different substrates so that even the refractive index of the optic film layer is relatively large, internal total reflection at an interface between the quantum dot color filter plate and the optic film layer and emission angles of light beams being not convergent toward a normal line due to the refractive index may not happen so as to effectively eliminate interference caused by the refractive index of the optic film layer and improve the displaying performance of the liquid crystal display device.

### BACKGROUND OF THE INVENTION

### 1. Field of the Invention

The present invention relates to the field of display technology, and more particular to a liquid crystal display device.

### 2. The Related Arts

The development of science and technology and the progress of human society make people increasingly rely on exchange and transmission of information. As a major carrier, as well as a physical basis, for exchange and transmission of information, a display device is now a hot spot and highland that scientists who devote themselves to study and research in the field of photoelectronics must capture.

Quantum dots (QDs) are generally extremely tiny organic nanometer crystals that are not visually observable and are mostly nanometer materials having a three-dimensional configuration made of elements of II-VI groups or III-V groups. Due to the quantum confinement effect, transportation of electrons and holes in the interior is constrained and a continuous energy band is converted into a discrete energy level structure. Once receiving excitation of external energy, such as light or electricity, the quantum dots give off a color light and the color of the light is determined by the constituent materials, size and shape of the quantum dots. Different sizes of quantum dots provide different extents of quantum confinement for electrons and holes so that the discrete energy level structures are different. Generally, the smaller the particles are, the longer the wavelength that will be absorbed would be; and the larger the particles are, the shorter the wavelength that will be absorbed would be. Regular quantum dots absorb blue light that has a relatively short wavelength and will be excited to give off color light of a longer wavelength. Such a characteristic allows the quantum dots to change the color of light emitting from a light source.

An advantage of quantum dots is that through adjustment of the size of the quantum dots, it is possible to realize emissive wavelength covering both infrared band and entire visible light band, and the band of the emissive light band can be made narrow and shows high degree of color saturation. The quantum dots have a high quantum dot conversion efficiency and the material shows stable property; the manufacturing method is simple, allowing for preparation from solutions and ensuring rich resources.

Heretofore, a liquid crystal display (LCD) provides colors by means of a color filter (CF) layer. A conventional color filter layer is formed by subjecting color resist materials to a series of photolithographic operations. The color resist materials are made by dissolving and distributing a polymer, a monomer, a photo initiator, and a pigment in a solvent. Recently, manufacturers, such as Samsung Electronics Co., Ltd., proposed an idea of using a quantum dot color filter (QDCF) made of quantum dot materials to replace the conventional color filter plate.

Making a QDCF with QD nanometer materials requires solvents and ligands used in combination and certain progress has been made in this field. For example, some patent documents have been available concerning fabrication of color filter plates with quantum dots. However, the quantum dot color filter plates proposed in these patent documents are arranged inside liquid crystal cells. Since the principles based on which colors are generated are different between the quantum dots and the commonly used pigments of the color filter plates, where light emission of the quantum dots is achieved through excitation by light to cause a change of the energy band structure of the quantum dot so as to emit a specific wavelength of light, if the common way that a polarizer (POL) is attached to an outside surface of a glass backing a liquid crystal display is still adopted, then backlight that passes through a lower polarizer generates linear polarization light polarized at a specific direction and when the linear polarization light is applied to excite quantum dots, the polarized light in the specific direction would change the polarization condition thereof (such as de-polarization or variation of polarization direction). This results in uncontrollability concerning light path and brightness.

To prevent the above problems, a polarizer structure must be added between the QDCF and a liquid crystal layer. As shown in FIG. 1, which is a schematic view illustrating a structure of a conventional liquid crystal display device, the liquid crystal display device comprises a liquid crystal panel 10 and a backlight module 50 arranged under the liquid crystal panel 10. The liquid crystal panel 10 comprises a first substrate 20 and a second structure 30 that are respectively arranged at upper and lower sides and opposite to each other and a liquid crystal layer 40 arranged between the first substrate 20 and the second substrate 30. The first substrate 20 comprises a first backing plate 21 and an optic film layer 22, a quantum dot color filter layer 23, a planarization layer 24, an upper polarizer 25, and an electrode layer 26 that are arranged, in sequence, on a side of the first backing plate 21 that is adjacent to the liquid crystal layer 40; and the second substrate 30 comprises a second backing plate 31, a thin-film transistor (TFT) layer 32 arranged on a side of the second backing plate 31 that is adjacent to the liquid crystal layer 40, and a lower polarizer 33 arranged on a side of the second backing plate 31 that is distant from the liquid crystal layer 40, wherein due to high sensitivity of the QD materials to moisture and oxygen, the planarization layer 24 is provided between the upper polarizer 25 and the quantum dot color filter layer 23 for planarization of the quantum dot color filter layer 23 and protection of the quantum dot color filter layer 23. Further, the operation mechanism of the quantum dot color filter layer 23 is photoluminescence, where the conversion achievable by such excitation does not provide an efficiency of 100% and thus, additional filtration must be taken for light transmitting through the quantum dot color filter layer 23 in order to remove an extra portion of the backlighting given off from a top surface of the quantum dot color filter layer 23. This is the function that the optic film layer 22 is provided for.

However, for the structure of the liquid crystal display device shown in FIG. 1, when the optic film layer 22 has a large refractive index, total internal reflection may occur at an interface between the quantum dot color filter layer 23 and the optic film layer 22, or the refractive index may make emission angles of light beams projected outward not converge toward a normal line, making it adverse for the displaying performance of the display device.

In view of the above problems, it is desired to provide a novel structure for liquid crystal display devices.

### SUMMARY OF THE INVENTION

An objective of the present invention is to provide a liquid crystal display device, in which a quantum dot color filter plate and an optic film layer are provided on separate substrates to effectively eliminate interference caused by the refractive index of the optic film layer and improve the displaying performance of the liquid crystal display device.

To achieve the above objective, the present invention provides a liquid crystal display device, which comprises a liquid crystal panel and a backlight module;

wherein the liquid crystal panel comprises a first substrate and a second substrate respectively arranged at upper and lower sides and opposite to each other and a liquid crystal layer arranged between the first substrate and the second substrate, wherein the second substrate comprises an array substrate, which comprises a thin-film transistor (TFT) layer;

the first substrate and the second substrate respectively comprise one of the quantum dot color filter plate and the optic film layer, wherein the optic film layer provides a function of wave filtration; and

the backlight module is arranged on an upper or lower side of the liquid crystal panel and the quantum dot color filter plate is located between the backlight module and the optic film layer, wherein the optic film layer functions to remove an extra amount of backlighting emitting from the backlight module after transmission through the quantum dot color filter plate.

The first substrate further comprises a first backing plate and an upper polarization layer; and

the second substrate further comprises a second backing plate and a lower polarization layer.

The first substrate comprises the quantum dot color filter plate and the second substrate comprises the optic film layer;

the backlight module is arranged on the upper side of the liquid crystal panel;

the first substrate further comprises an encapsulation layer and a function layer; and

in the first substrate, the quantum dot color filter plate, the encapsulation layer, the upper polarization layer, and the function layer are arranged, in sequence from the upper side to the lower side, on a side of the first backing plate that is adjacent to the liquid crystal layer.

The first substrate comprises the optic film layer and the second substrate comprises the quantum dot color filter plate;

the backlight module is arranged on the lower side of the liquid crystal panel; and

the second substrate further comprises an encapsulation layer, a planarization layer, and a pixel electrode layer.

In the second substrate, the TFT layer, the planarization layer, the quantum dot color filter plate, the encapsulation layer, the lower polarization layer, and the pixel electrode layer are arranged, in sequence from the lower side to the upper side, on side of the second backing plate that is adjacent to the liquid crystal layer.

In the second substrate, the quantum dot color filter plate, the encapsulation layer, the TFT layer, the planarization layer, the lower polarization layer, and the pixel electrode layer are arranged, in sequence from the lower side to the upper side, on a side of the second backing plate that is adjacent to the liquid crystal layer.

In the second substrate, the quantum dot color filter plate, the encapsulation layer, the lower polarization layer, the planarization layer, the TFT layer, and the pixel electrode layer are arranged, in sequence from the lower side to the upper side, on a side of the second backing plate that is adjacent to the liquid crystal layer.

The lower polarization layer comprises a metal nanometer wire-grid polarization plate;

the second substrate comprises a via formed therein and extending through the lower polarization layer to allow the pixel electrode layer to electrically connect, through the via, to the TFT layer; and

the lower polarization layer is formed through nanoimprint lithography by means of a nanoimprint template, wherein a process conducted to form the via in the lower polarization layer is that in applying the nanoimprint lithography to form the lower polarization layer, a via pattern is formed in the lower polarization layer and then, an etching operation that is conducted subsequently removes metal from the via pattern so as to form the via in the lower polarization layer.

The quantum dot color filter plate comprises a pixel separation layer and a red pixel unit, a green pixel unit, and a blue pixel unit that are separated from each other by the pixel separation layer; and

the backlight module comprises a blue fluorescent light source and the red pixel unit and the green pixel unit are respectively formed of a red quantum dot ink material and green quantum dot ink material each applied through an inkjet printing operation, and the blue pixel unit is formed of a material comprising a transparent organic material.

The optic film layer is formed through a patterning operation and is provided for removing blue fluorescent light that emits from the backlight module and is not converted after transmission through the red pixel unit and the green pixel unit.

The present invention also provides a liquid crystal display device, which comprises a liquid crystal panel and a backlight module;

wherein the liquid crystal panel comprises a first substrate and a second substrate respectively arranged at upper and lower sides and opposite to each other and a liquid crystal layer arranged between the first substrate and the second substrate, wherein the second substrate comprises an array substrate, which comprises a thin-film transistor (TFT) layer;

the first substrate and the second substrate respectively comprise one of the quantum dot color filter plate and the optic film layer, wherein the optic film layer provides a function of wave filtration; and

the backlight module is arranged on an upper or lower side of the liquid crystal panel and the quantum dot color filter plate is located between the backlight module and the optic film layer, wherein the optic film layer functions to remove an extra amount of backlighting emitting from the backlight module after transmission through the quantum dot color filter plate;

wherein the first substrate further comprises a first backing plate and an upper polarization layer; and

the second substrate further comprises a second backing plate and a lower polarization layer; and

wherein the quantum dot color filter plate comprises a pixel separation layer and a red pixel unit, a green pixel unit, and a blue pixel unit that are separated from each other by the pixel separation layer; and

the backlight module comprises a blue fluorescent light source and the red pixel unit and the green pixel unit are respectively formed of a red quantum dot ink material and green quantum dot ink material each applied through an inkjet printing operation, and the blue pixel unit is formed of a material comprising a transparent organic material.

The efficacy of the present invention is that the present invention provides a liquid crystal display device, which comprises a liquid crystal panel comprising a first substrate and a second substrate respectively arranged at upper and lower sides and opposite to each other, wherein the first substrate and the second substrate respectively comprise one of a quantum dot color filter plate and an optic film layer. The present invention is structured to have the quantum dot color filter plate and the optic film layer respectively arranged on different substrates so that even the refractive index of the optic film layer is relatively large, internal total reflection at an interface between the quantum dot color filter plate and the optic film layer and emission angles of light beams being not convergent toward a normal line due to the refractive index may not happen so as to effectively eliminate interference caused by the refractive index of the optic film layer and improve the displaying performance of the liquid crystal display device.

### BRIEF DESCRIPTION OF THE DRAWINGS

The technical solution, as well as other beneficial advantages, of the present invention will become apparent from the following detailed description of embodiments of the present invention, with reference to the attached drawings.

In the drawings:

FIG. 1 is a schematic view showing a structure of a conventional liquid crystal display device;

FIG. 2 is a schematic view showing a structure of a first embodiment of a liquid crystal display device according to the present invention;

FIG. 3 is a schematic view showing a structure of a quantum dot color filter plate included in the liquid crystal display device according to the present invention;

FIG. 4 is a schematic view showing a structure of a second embodiment of the liquid crystal display device according to the present invention;

FIG. 5 is a cross-sectional view showing a lower polarization layer of the second embodiment of the liquid crystal display device according to the present invention;

FIG. 6 is a schematic, top plan view illustrating formation of vias in the lower polarization layer of the second embodiment of the liquid crystal display device according to the present invention;

FIG. 7 is a schematic view showing a structure of a third embodiment of the liquid crystal display device according to the present invention; and

FIG. 8 is a schematic view showing a structure of a fourth embodiment of the liquid crystal display device according to the present invention.

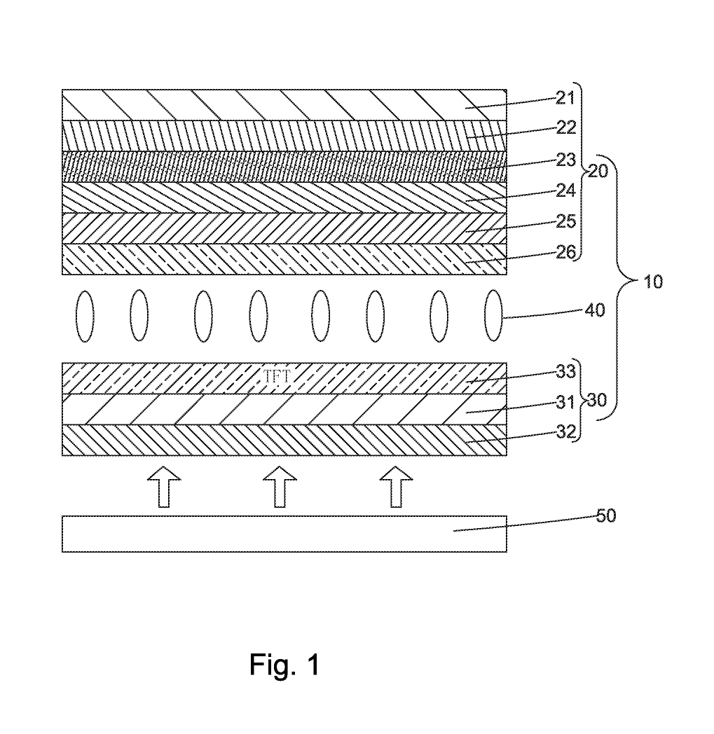

### DETAILED DESCRIPTION OF THE PREFERRED EMBODIMENTS

To further expound the technical solution adopted in the present invention and the advantages thereof, a detailed description will be given with reference to the preferred embodiments of the present invention and the drawings thereof.

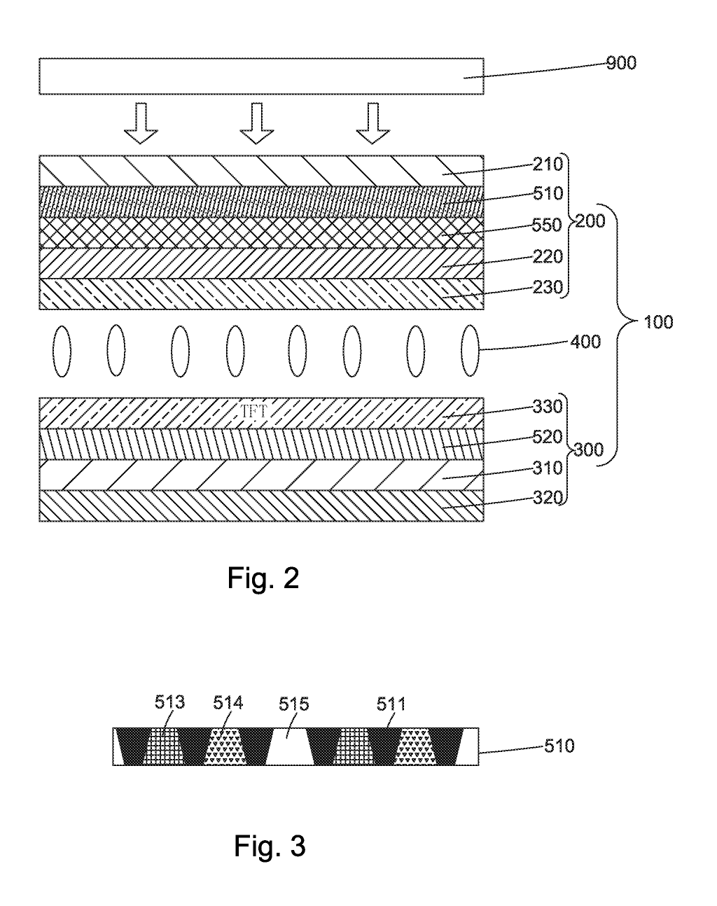

The present invention provides a liquid crystal display device, in which a quantum dot color filter plate 510 and an optic film layer 520 are arranged on different substates in order to effectively elminates interference caused by the refrative index of the optic film layer 520 and improve displaying performance of the liquid crystal display device. Specifically, reference being had to FIG. 2, which is a schematic view showing a structure of a first embodiment of a liquid crystal display device according to the present invention, in the instant embodiment, the liquid crystal display device comprises a liquid crystal panel 100 and a backlight module 900.

The liquid crystal panel 100 comprises a first substrate 200 and a second substrate 300 respectively arranged at upper and lower sides and opposite to each other and a liquid crystal layer 400 arranged between the first substrate 200 and the second substrate 300, wherein the second substrate 300 is an array substrate, which comprises a thin-film transistor (TFT) layer 330 thereon.

The first substrate 200 and the second substrate 300 respectively comprise one of the quantum dot color filter plate 510 and the optic film layer 520 arranged thereon, wherein the optic film layer 520 provides a function of wave filtration.

The backlight module 900 is arranged on an upper or lower side of the liquid crystal panel 100 and the quantum dot color filter plate 510 is located between the backlight module 900 and the optic film layer 520. The optic film layer 520 functions to remove an extra amount of backlighting emitting from the backlight module 900 after transmission through the quantum dot color filter plate 510.

Specifically, the first substrate 200 further comprises a first backing plate 210 and an upper polarization layer 220; and the second substrate 300 further comprises a second backing plate 310 and a lower polarization layer 320.

Specifically, in the instant embodiment, the first substrate 200 comprises the quantum dot color filter plate 510 and the second substrate 300 comprises the optic film layer 520; and the backlight module 900 is arranged on the upper side of the liquid crystal panel 100.

Specifically, the first substrate 200 further comprises an encapsulation layer 550 for planarization of the quantum dot color filter plate 510 and encapsulation and thus protection of the quantum dot color filter plate 510 and a function layer 230 for electrode and/or alignment; and in the first substrate 200, the quantum dot color filter plate 510, the encapsulation layer 550, the upper polarization layer 220, and the function layer 230 are arranged, in sequence from the upper side to the lower side, on a side of the first backing plate 210 that is adjacent to the liquid crystal layer 400.

Specifically, as shown in FIG. 3, the quantum dot color filter plate 510 comprises a pixel separation layer 511 and a red pixel unit 513, a green pixel unit 514, and a blue pixel unit 515 that are separated from each other by the pixel separation layer 511.

Specifically, the backlight module 900 comprises a blue fluorescent light source. The red pixel unit 513 and the green pixel unit 514 are respectively formed of a red quantum dot ink material and green quantum dot ink material each applied through an inkjet printing operation. Since blue light carries higher energy, which may excite a red quantum dot (that is a quantum dot that emits red light) and a green quantum dot (that is a quantum dot that emits green light) to respectively generate red light and green light, the backlight module 900 that generates blue fluorescent light may serve as a backlighting source such that blue light is supplied by the backlight module 900 itself, and thus, a blue pixel unit 515 may be formed by filling a transparent organic material.

Specifically, the optic film layer 520 is formed through a patterning operation and is provided for removing the blue fluorescent light that emits from the backlight module 900 but has not yet been converted after transmission through the red pixel unit 513 and the green pixel unit 514.

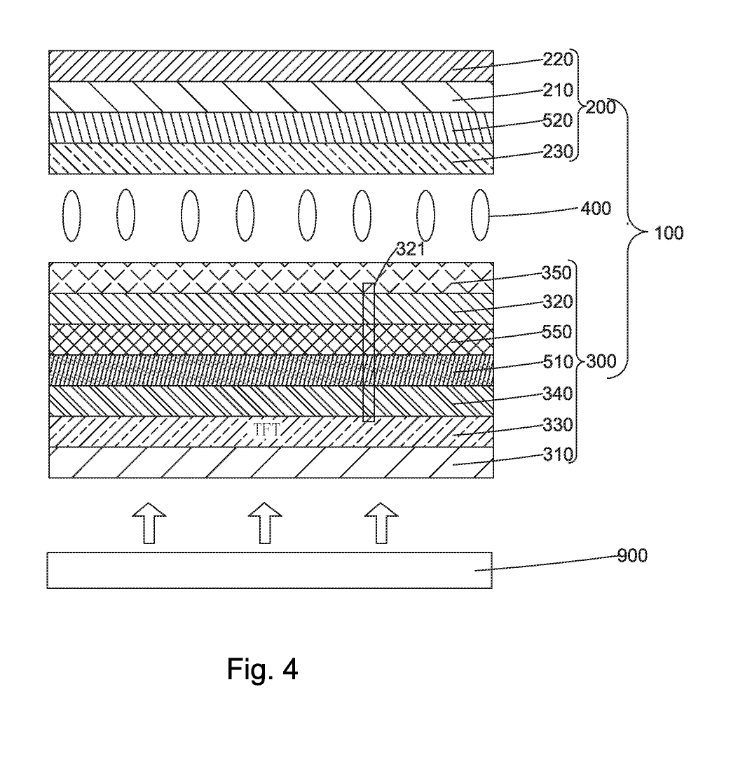

Referring to FIG. 4, which is a schematic view showing a structure of a second embodiment of the liquid crystal display device according to the present invention, in the instant embodiment, the liquid crystal display device comprises a liquid crystal panel 100 and a backlight module 900.

The liquid crystal panel 100 comprises a first substrate 200 and a second substrate 300 respectively arranged at upper and lower sides and opposite to each other and a liquid crystal layer 400 arranged between the first substrate 200 and the second substrate 300, wherein the second substrate 300 is an array substrate, which comprises a thin-film transistor (TFT) layer 330 thereon.

In the instant embodiment, the first substrate 200 comprises an optic film layer 520 and the second substrate 300 comprises a quantum dot color filter plate 510, wherein the optic film layer 520 provides a function of wave filtration.

The backlight module 900 is arranged on the lower side of the liquid crystal panel 100 and the optic film layer 520 is located between the backlight module 900 and the quantum dot color filter plate 510 and functions to remove an extra amount of backlighting emitting from the backlight module 900 after transmission through the quantum dot color filter plate 510.

Specifically, the first substrate 200 further comprises a first backing plate 210 and an upper polarization layer 220; and the second substrate 300 further comprises a second backing plate 310, a lower polarization layer 320, an encapsulation layer 550, a planarization layer 340, and a pixel electrode layer 350.

Specifically, in the second substrate 300, the TFT layer 330, the planarization layer 340, the quantum dot color filter plate 510, the encapsulation layer 550, the lower polarization layer 320, and the pixel electrode layer 350 are arranged, in sequence from the lower side to the upper side, on a side of the second backing plate 310 that is adjacent to the liquid crystal layer 400.

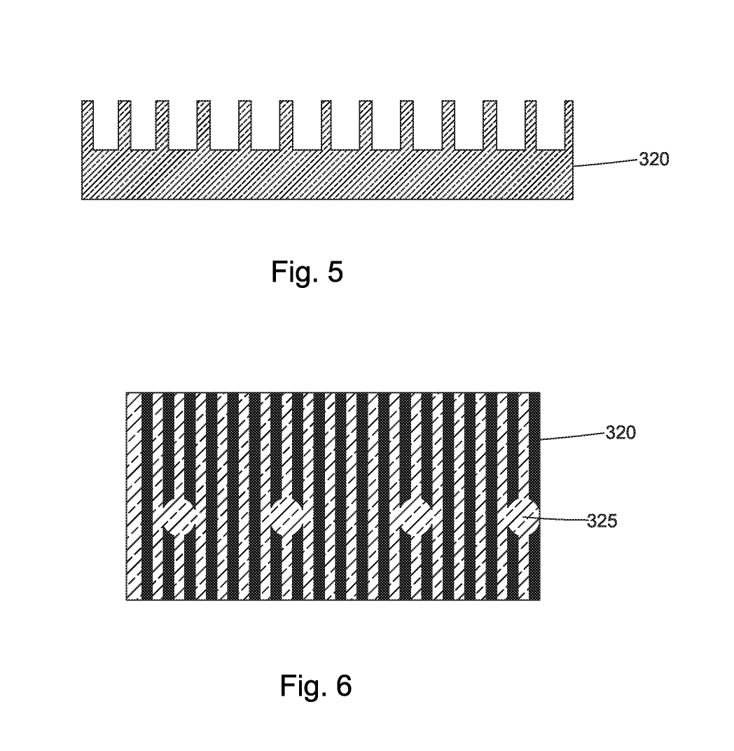

Specifically, as shown in FIG. 5, the lower polarization layer 320 comprises a metal nanometer wire-grid polarization plate.

Specifically, the second substrate 300 comprises a via 321 extending through the lower polarization layer 320. Further, in the instant embodiment, the via 321 necessarily extends through the planarization layer 340, the quantum dot color filter plate 510, the encapsulation layer 550, and the lower polarization layer 320 that are located between the pixel electrode layer 350 and the TFT layer 330 in order to allow the pixel electrode layer 350 to electrically connect to the TFT layer 330 through the via 321.

Specifically, the lower polarization layer 320 is formed through nanoimprint lithography by means of a nanoimprint template and, thus, as shown in FIG. 6, a process for forming the via 321 in the lower polarization layer 320 is that in applying nanoimprint lithography to form the lower polarization layer 320, a via pattern 325 is formed in the lower polarization layer 320 and then, an etching operation that is conducted subsequently removes metal from the via pattern 325 so as to form the via 321 in the lower polarization layer 320.

Specifically, the quantum dot color filter plate 510 comprises a pixel separation layer 511 and a red pixel unit 513, a green pixel unit 514, and a blue pixel unit 515 that are separated from each other by the pixel separation layer 511; and the backlight module 900 comprises a blue fluorescent light source, and the red pixel unit 513 and the green pixel unit 514 are respectively formed of a red quantum dot ink material and green quantum dot ink material each applied through an inkjet printing operation, and the blue pixel unit 515 comprises a transparent organic material.

Specifically, the optic film layer 520 is formed through a patterning operation and is provided for removing the blue fluorescent light that emits from the backlight module 900 but has not yet been converted after transmission through the red pixel unit 513 and the green pixel unit 514.

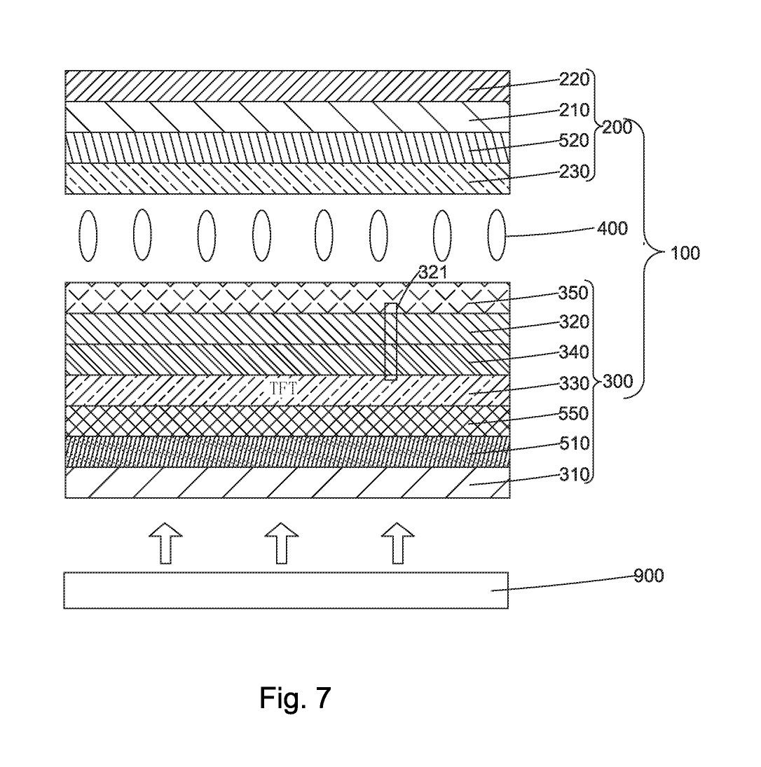

Referring to FIG. 7, which is a schematic view showing a structure of a thrid embodiment of the liquid crystal display device according to the present invention, compared to the second embodiment described above, the instant embodiment is structured such that in the second substrate 300, the quantum dot color filter plate 510, the encapsulation layer 550, the TFT layer 330, the planarization layer 340, the lower polarization layer 320, and the pixel electrode layer 350 are arranged, in sequence from the lower side to the upper side, on a side of the second backing plate 310 that is adjacent to the liquid crystal layer 400, such that the via 321 that provides electrical connection between the pixel electrode layer 350 and the TFT layer 330 only needs to extend through the planarization layer 340 and the lower polarization layer 320 that are located between the pixel electrode layer 350 and the TFT layer 330. The remaining features are similar to those of the second embodiment described above and repeated description will be omitted herein.

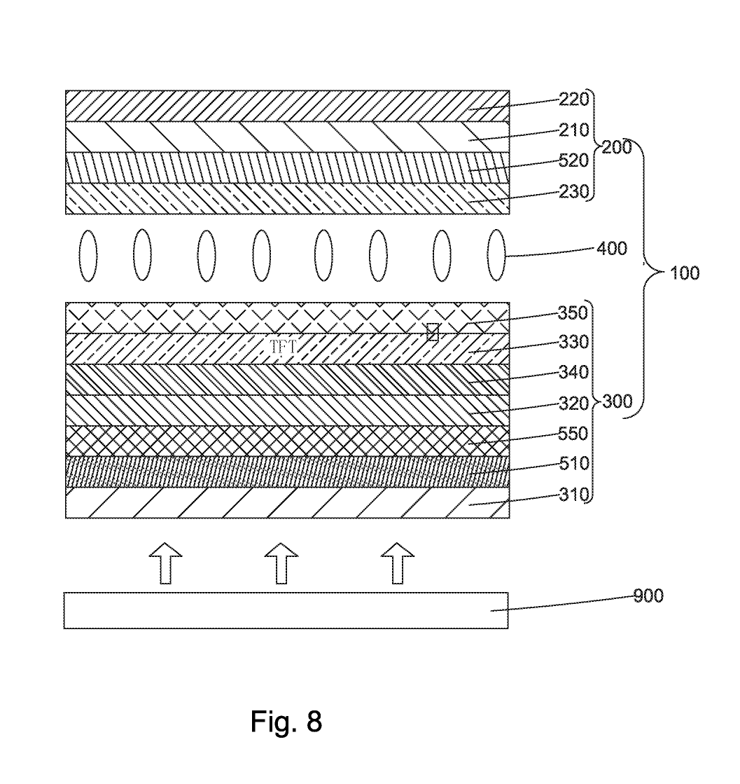

Referring to FIG. 8, which is a schematic view showing a structure of a fourth embodiment of the liquid crystal display device according to the present invention, compared to the second embodiment described above, the instant embodiment is structured such that in the second substrate 300, the quantum dot color filter plate 510, the encapsulation layer 550, the lower polarization layer 320, the planarization layer 340, the TFT layer 330, and the pixel electrode layer 350 are arranged, in sequence from the lower side to the upper side, on a side of the second backing plate 310 that is adjacent to the liquid crystal layer 400. As a result, there is no need to form a via 321 in the lower polarization layer 320 and the pixel electrode layer 350 and the TFT layer 330 are directly set in electrical connection with each other. The remaining features are similar to those of the second embodiment described above and repeated description will be omitted herein.

In summary, the present invention provides a liquid crystal display device, which comprises a liquid crystal panel comprising a first substrate and a second substrate respectively arranged at upper and lower sides and opposite to each other, wherein the first substrate and the second substrate respectively comprise one of a quantum dot color filter plate and an optic film layer. The present invention is structured to have the quantum dot color filter plate and the optic film layer respectively arranged on different substrates so that even the refractive index of the optic film layer is relatively large, internal total reflection at an interface between the quantum dot color filter plate and the optic film layer and emission angles of light beams being not convergent toward a normal line due to the refractive index may not happen so as to effectively eliminate interference caused by the refractive index of the optic film layer and improve the displaying performance of the liquid crystal display device.

Based on the description given above, those having ordinary skills in the art may easily contemplate various changes and modifications of he technical solution and the technical ideas of the present invention. All these changes and modifications are considered belonging to the protection scope of the present invention as defined in the appended claims.

What is claimed is:

1. A liquid crystal display device, comprising a liquid crystal panel and a backlight module;
wherein the liquid crystal panel comprises a first substrate and a second substrate respectively arranged at upper and lower sides and opposite to each other and a liquid crystal layer arranged between the first substrate and the second substrate, wherein the second substrate comprises an array substrate, which comprises a thin-film transistor (TFT) layer;
the first substrate and the second substrate respectively comprise one of the quantum dot color filter plate and the optic film layer, wherein the optic film layer provides a function of wave filtration; and
the backlight module is arranged on an upper or lower side of the liquid crystal panel and the quantum dot color filter plate is located between the backlight module and the optic film layer, wherein the optic film layer functions to remove an extra amount of backlighting emitting from the backlight module after transmission through the quantum dot color filter plate.

2. The liquid crystal display device as claimed in claim 1, wherein the first substrate further comprises a first backing plate and an upper polarization layer; and
the second substrate further comprises a second backing plate and a lower polarization layer.

3. The liquid crystal display device as claimed in claim 2, wherein the first substrate comprises the quantum dot color filter plate and the second substrate comprises the optic film layer;
the backlight module is arranged on the upper side of the liquid crystal panel;
the first substrate further comprises an encapsulation layer and a function layer; and
in the first substrate, the quantum dot color filter plate, the encapsulation layer, the upper polarization layer, and the function layer are arranged, in sequence from the upper side to the lower side, on a side of the first backing plate that is adjacent to the liquid crystal layer.

4. The liquid crystal display device as claimed in claim 2, wherein the first substrate comprises the optic film layer and the second substrate comprises the quantum dot color filter plate;
the backlight module is arranged on the lower side of the liquid crystal panel; and
the second substrate further comprises an encapsulation layer, a planarization layer, and a pixel electrode layer.

5. The liquid crystal display device as claimed in claim 4, wherein in the second substrate, the TFT layer, the planarization layer, the quantum dot color filter plate, the encapsulation layer, the lower polarization layer, and the pixel electrode layer are arranged, in sequence from the lower side to the upper side, on side of the second backing plate that is adjacent to the liquid crystal layer.

6. The liquid crystal display device as claimed in claim 4, wherein in the second substrate, the quantum dot color filter plate, the encapsulation layer, the TFT layer, the planarization layer, the lower polarization layer, and the pixel electrode layer are arranged, in sequence from the lower side to the upper side, on a side of the second backing plate that is adjacent to the liquid crystal layer.

7. The liquid crystal display device as claimed in claim 4, wherein in the second substrate, the quantum dot color filter plate, the encapsulation layer, the lower polarization layer, the planarization layer, the TFT layer, and the pixel electrode layer are arranged, in sequence from the lower side to the upper side, on a side of the second backing plate that is adjacent to the liquid crystal layer.

8. The liquid crystal display device as claimed in claim 5, wherein the lower polarization layer comprises a metal nanometer wire-grid polarization plate;
the second substrate comprises a via formed therein and extending through the lower polarization layer to allow the pixel electrode layer to electrically connect, through the via, to the TFT layer; and
the lower polarization layer is formed through nanoimprint lithography by means of a nanoimprint template, wherein a process conducted to form the via in the lower polarization layer is that in applying the nanoimprint lithography to form the lower polarization layer, a via pattern is formed in the lower polarization layer and then, an etching operation that is conducted subsequently removes metal from the via pattern so as to form the via in the lower polarization layer.

9. The liquid crystal display device as claimed in claim 1, wherein the quantum dot color filter plate comprises a pixel separation layer and a red pixel unit, a green pixel unit, and a blue pixel unit that are separated from each other by the pixel separation layer; and
the backlight module comprises a blue fluorescent light source and the red pixel unit and the green pixel unit are respectively formed of a red quantum dot ink material and green quantum dot ink material each applied through an inkjet printing operation, and the blue pixel unit is formed of a material comprising a transparent organic material.

10. The liquid crystal display device as claimed in claim 9, wherein the optic film layer is formed through a patterning operation and is provided for removing blue fluorescent light that emits from the backlight module and is not converted after transmission through the red pixel unit and the green pixel unit.

11. A liquid crystal display device, comprising a liquid crystal panel and a backlight module;
wherein the liquid crystal panel comprises a first substrate and a second substrate respectively arranged at upper and lower sides and opposite to each other and a liquid crystal layer arranged between the first substrate and the second substrate, wherein the second substrate comprises an array substrate, which comprises a thin-film transistor (TFT) layer;
the first substrate and the second substrate respectively comprise one of the quantum dot color filter plate and the optic film layer, wherein the optic film layer provides a function of wave filtration; and
the backlight module is arranged on an upper or lower side of the liquid crystal panel and the quantum dot color filter plate is located between the backlight module and the optic film layer, wherein the optic film layer functions to remove an extra amount of backlighting emitting from the backlight module after transmission through the quantum dot color filter plate;
wherein the first substrate further comprises a first backing plate and an upper polarization layer; and
the second substrate further comprises a second backing plate and a lower polarization layer; and
wherein the quantum dot color filter plate comprises a pixel separation layer and a red pixel unit, a green pixel unit, and a blue pixel unit that are separated from each other by the pixel separation layer; and
the backlight module comprises a blue fluorescent light source and the red pixel unit and the green pixel unit are respectively formed of a red quantum dot ink material and green quantum dot ink material each applied through an inkjet printing operation, and the blue pixel unit is formed of a material comprising a transparent organic material.

12. The liquid crystal display device as claimed in claim 11, wherein the first substrate comprises the quantum dot color filter plate and the second substrate comprises the optic film layer;
the backlight module is arranged on the upper side of the liquid crystal panel;
the first substrate further comprises an encapsulation layer and a function layer; and
in the first substrate, the quantum dot color filter plate, the encapsulation layer, the upper polarization layer, and the function layer are arranged, in sequence from the upper side to the lower side, on a side of the first backing plate that is adjacent to the liquid crystal layer.

13. The liquid crystal display device as claimed in claim 11, wherein the first substrate comprises the optic film layer and the second substrate comprises the quantum dot color filter plate;
the backlight module is arranged on the lower side of the liquid crystal panel; and
the second substrate further comprises an encapsulation layer, a planarization layer, and a pixel electrode layer.

14. The liquid crystal display device as claimed in claim 13, wherein in the second substrate, the TFT layer, the planarization layer, the quantum dot color filter plate, the encapsulation layer, the lower polarization layer, and the pixel electrode layer are arranged, in sequence from the lower side to the upper side, on side of the second backing plate that is adjacent to the liquid crystal layer.

15. The liquid crystal display device as claimed in claim 13, wherein in the second substrate, the quantum dot color filter plate, the encapsulation layer, the TFT layer, the planarization layer, the lower polarization layer, and the pixel electrode layer are arranged, in sequence from the lower side to the upper side, on a side of the second backing plate that is adjacent to the liquid crystal layer.

16. The liquid crystal display device as claimed in claim 13, wherein in the second substrate, the quantum dot color filter plate, the encapsulation layer, the lower polarization layer, the planarization layer, the TFT layer, and the pixel electrode layer are arranged, in sequence from the lower side to the upper side, on a side of the second backing plate that is adjacent to the liquid crystal layer.

17. The liquid crystal display device as claimed in claim 15, wherein the lower polarization layer comprises a metal nanometer wire-grid polarization plate;
the second substrate comprises a via formed therein and extending through the lower polarization layer to allow the pixel electrode layer to electrically connect, through the via, to the TFT layer; and
the lower polarization layer is formed through nanoimprint lithography by means of a nanoimprint template, wherein a process conducted to form the via in the lower polarization layer is that in applying the nanoimprint lithography to form the lower polarization layer, a via pattern is formed in the lower polarization layer and then, an etching operation that is conducted subsequently removes metal from the via pattern so as to form the via in the lower polarization layer.

18. The liquid crystal display device as claimed in claim 11, wherein the optic film layer is formed through a patterning operation and is provided for removing blue fluorescent light that emits from the backlight module and is not converted after transmission through the red pixel unit and the green pixel unit.
